(19) United States
(12) Patent Application Publication
(10) Pub. No.: US 2009/0095676 A1
(43) Pub. Date: Apr. 16, 2009

(54) Carrier for Liquid Chromatography, Chromatographic Columns Packed With the Carrier, and Method of Separation of Organic Substances With the Columns

(76) Inventors: Masahiko Numata, Ibaraki (JP); Yoshie Aoyagi, Ibaraki (JP); Yoko Tsuda, Ibaraki (JP)

Correspondence Address: MORGAN LEWIS & BOCKIUS LLP, 1111 PENNSYLVANIA AVENUE NW, WASHINGTON, DC, 20004, US

(21) Appl. No.: 11/920,427

(22) PCT Filed: May 12, 2006
(86) PCT No.: PCT/JP2006/309533

§ 371 Date: Nov. 15, 2007

(30) Foreign Application Priority Data
May 16, 2005 (JP) 2005-142950
Feb. 16, 2006 (JP) 2006-039786

(51) Int. Cl. B01D 15/26

(52) U.S. Cl. 210/635; 210/198.2

(57) ABSTRACT

The present invention provides a chromatography carrier which can recover aromatic compounds such as PCB and polycyclic aromatic hydrocarbon from other substances specifically and quickly using small amounts of the carrier and an organic solvent, a chromatography column packed with the carrier and a method for efficiently separating organic compounds such as PCB and polycyclic aromatic hydrocarbon using the column.

According to the present invention, the chromatography carrier is constructed by directly immobilizing an organic group comprising sulfoxide represented by the following formula (1) to an organic solvent-insoluble support via covalent bond or ionic bond:

R₁—SO—R₂— (1)
wherein R₁ represents alkyl having from 1 to 3 carbon atoms, and R₂ a divalent hydrocarbon group having from 1 to 10 carbon atoms.

### TECHNICAL FIELD

The present invention relates to a liquid chromatography carrier which is suitably used in separating organic compounds including aromatic compounds, a chromatography column packed with the carrier and a method for separating organic compounds using the column.

### BACKGROUND OF THE INVENTION

Among organic compounds having aromatic rings, various environmental pollutants such as polynuclear aromatic hydrocarbon (PAH) including benzopyrene which shows carcinogenicity and a class of benzene, toluene and the like which are known as air pollutants are known. Although it is necessary to appropriately monitor their concentrations in the environment, their accurate analysis is not easy in general.

When the case of polychlorobiphenyl (PCB) which is an important pollutant and also is an aromatic compound is used as basis of explanation, it is difficult in general to separate PCB contained in various media such as waste water, waste oil and food from oil contents having similar physical and chemical properties such as mineral oil. Furthermore, contamination of these interfering substances frequently causes the fouling of a gas chromatography apparatus for the determination and the reduction of PCB analysis accuracy. Therefore, it is necessary in general to apply a sample to the gas chromatography after separating PCB from the sample matrix to a certain degree.

For example, in the “Method for verifying criteria concerned in the special control industrial wastes (written in Japanese)” (the Ministry of Health and Welfare Notification No. 192, 1992, revised as No. 222 in august, 1998) which is an official regulation analytical method of PCB in insulating oil and the JIS K0093 which is an official regulation analytical method of industrial waste water and the like, methods such as extraction and separation of PCB from the majority of oil contents by a polar solvent: dimethyl sulfoxide; degradation and elimination of interfering substances by a strong acid: concentrated sulfuric acid or fuming sulfuric acid or a strong alkali: potassium hydroxide; alternate separation of each components by a chromatography using carrier such as silica gel and alumina are defined, and a separation operation using a gel permeation chromatography has also been developed in recent years (cf., Non-patent Reference 1).

### Non-patent Reference 1: Kankyo Kagaku, 2003, [13], p. 1033

However, the liquid-liquid extraction method using a polar solvent, strong acid, strong alkali or the like has problems not only that operation thereof is complex but also that it requires a relatively large amount of reagent having high toxicity.

On the other hand, the chromatography has a high reliability as a means for the alternate separation of substances. The operation method thereof is also relatively convenient. Thus, a method in which so-called normal phase column which uses a carrier having hydrophilic surface, such as those in which the silica gel surface is modified with aminopropyl, cyano or the like, in addition to the aforementioned silica gel, alumina and the like, is used and hexane or the like non- to slightly polar solvent is used as the mobile phase is broadly used for the purpose of separating PCB and the like (e.g., see Non-patent Reference 2 and Patent Reference 1).

### Non-patent Reference 2: Fresenius Journal of Analytical Chemistry, 1993, [346], p. 766

### Patent Reference 1: JP-A-2003-114222

However, in the both methods of such a normal phase chromatography and the aforementioned gel permeation chromatography, it is necessary in general to carry out elution with a large volume of an organic solvent using a very long column for effecting sufficient separation. Therefore, it can be said that there is a room for improvement in terms of the efficiency and cost of operation and safety and environment for operators.

### DISCLOSURE OF THE INVENTION

### Problems to be Solved by the Invention

Accordingly, the present invention aims at providing a chromatography carrier which can recover aromatic compounds such as PCB from other substances specifically and quickly using small amounts of the carrier and an organic solvent, a chromatography column packed with the carrier and a method for efficiently separating organic compounds such as PCB using the column, by solving the aforementioned problems involved in the related art.

### Means for Solving the Problems

As a result of conducting intensive studies, the inventors of the present invention have found that the aforementioned problems can be solved by constructing a chromatography carrier through direct immobilization of an organic group containing sulfoxide to an organic solvent-insoluble support by covalent bond or ionic bond, and thereby accomplished the present invention.

(I) A chromatography carrier, in which an organic group comprising sulfoxide represented by the following formula (1) is directly immobilized to an organic solvent-insoluble support via covalent bond or ionic bond:

R₁—SO—R₂— (1)

wherein R₁ represents alkyl having from 1 to 3 carbon atoms, and R₂ represents a divalent hydrocarbon group having from 1 to 10 carbon atoms.

(II) The chromatography carrier according to (I), wherein the chromatography carrier is a chromatography carrier for an aromatic compound.

(III) The chromatography carrier according to (I) or (II), wherein the organic group comprising the sulfoxide represented by the aforementioned formula (1) is immobilized to the support via imine bond, amido bond or ester bond, or siloxane bond.

(IV) The chromatography carrier according to any one of (I) to (III), wherein the support is a porous particle selected from the group consisting of a polystyrene resin, a polyvinyl alcohol resin, titania and silica gel.

(V) The chromatography carrier according to any one of (I) to (IV), wherein particle diameter of the porous particle as the support is from 5 to 200 μm, and specific surface area thereof is from 100 to 700 m²/g.

(VI) The chromatography carrier according to any one of (I) to (V), wherein content of the sulfoxide represented by the aforementioned formula (1) is from 0.2 to 2.5 mmol/g per the support.

(VII) A chromatography column, in which the chromatography carrier described in any one of (I) to (VI) is packed.

(VIII) A method for separating an aromatic compound, which comprises adding a sample containing an aromatic compound to the chromatography column described in (VII) to elute components other than the aromatic compound with a non-polar solvent, followed by eluting the aromatic compound successively with the non-polar solvent or with a solvent containing a polar solvent.

(IX) The method for separating an aromatic compound according to (VIII), wherein the aromatic compound is a halogenated aromatic compound.

(X) The method for separating an aromatic compound according to (IX), wherein the halogenated aromatic compound is polychlorobiphenyl.

(XI) The method for separating an aromatic compound according to (VIII), wherein the aromatic compound is a polycyclic aromatic hydrocarbon.

### EFFECT OF THE INVENTION

According to the present invention, it is able to obtain a chromatography carrier which can recover aromatic compounds such as PCB and PAH specifically and quickly from other substances using small amounts of the carrier and an organic solvent, without requiting elution by a very long column and a large volume of the organic solvent. Additionally, by the use of a column packed with the chromatography carrier, aromatic compounds such as PCB and PAH can be efficiently separated.

### BRIEF DESCRIPTION OF THE DRAWINGS

FIG. 1 is a graph showing amount of the solvent used in the elution and oil contents eluted from the separation column and recovery yield of PCB in Example 2.

FIG. 2 is a graph showing amount of the solvent used in the elution and oil contents eluted from the separation column and recovery yield of PCB in Example 4.

FIG. 3 is a graph showing amount of the solvent used in the elution and oil contents eluted from the separation column and recovery yield of PCB in Comparative Example 1.

FIG. 4 is a graph showing amount of the solvent used in the elution and oil contents eluted from the separation column and recovery yield of PCB in Example 10.

FIG. 5 is a graph showing amount of the solvent used in the elution and oil contents eluted from the separation column and recovery yield of PAH in Example 12.

FIG. 6 is a graph showing amount of the solvent used in the elution and oil contents eluted from the separation column and recovery yield of PCB in Example 13.

FIG. 7 is a graph showing amount of the solvent used in the elution and oil contents eluted from the separation column and recovery yield of PCB in Example 14.

### BEST MODE FOR CARRYING OUT THE INVENTION

In the present invention, a chromatography carrier is constructed by directly immobilizing an organic group comprising sulfoxide represented by the following formula (1) to an organic solvent-insoluble support by covalent bond or ionic bond.

R₁—SO—R₂— (1)

(In the formula, R₁ represents alkyl having from 1 to 3 carbon atoms, and R₂ represents a divalent hydrocarbon group having from 1 to 10 carbon atoms).

To immobilize the organic group comprising sulfoxide represented by the aforementioned formula (1) to the organic solvent-insoluble support, for example, a sulfoxide compound represented by the following formula (2), wherein alkyl having approximately from 1 to 3 carbon atoms (R₁) and an aliphatic or aromatic hydrocarbon backbone (R₂) are linked to SO and the R₂ further has one or more of functional group X such as hydroxyl, amino, carboxyl, formyl, chlorosilyl and alkoxysilyl which are necessary in binding to the support, can be used,

R₁—SO—R₂—X (2)

(In the formula, R₁ represents alkyl having from 1 to 3 carbon atoms, R₂ represents a divalent hydrocarbon group having from 1 to 10 carbon atoms, and X represents hydroxyl, amino, carboxyl, formyl, chlorosilyl or alkoxysilyl).

In this connection, as the R₂ in the aforementioned formula, it is preferable to use an aliphatic or aromatic hydrocarbon group having from 1 to 10 carbon atoms. Examples of particularly suitable R₂ include an aliphatic hydrocarbon having from 1 to 4 carbon atoms and benzyl. When the number of carbon atoms of R₂ is too large, the aliphatic hydrocarbon or the like are also kept on the carrier due to hydrophilic interaction. As a result, separation efficiency is reduced.

When it is difficult to obtain such compounds having sulfoxide, a corresponding sulfide compound may be converted into sulfoxide by oxidizing it using approximately from 1.0 to 1.2 times moles of an appropriate oxidizing agent such as hydrogen peroxide or a periodate, before or after binding to the support.

Although the solvent-insoluble support in the present invention is not particularly limited as long as it has a functional group which can binds to the aforementioned functional group, it is most preferable to use porous spherical particles for the purpose of effecting sufficient interaction between the substances to be separated and sulfoxide by binding the sulfoxide to the support at a high density, while simultaneously effecting good separation between the substances by suppressing disorder of flow of the mobile phase. For the purpose, for example, organic polymers such as polystyrene and polyvinyl alcohol, inorganic substances such as silica gel, and those in which a necessary functional group is introduced by chemically modifying their surfaces, can be used.

According to the present invention, the chromatography carrier can be prepared by directly immobilizing the aforementioned sulfoxide compound to the support via covalent bond or ionic bond by appropriately applying a conventionally known reaction.

As an example of such a reaction, amino directly reacts with formyl and they mutually bind as imine by dehydration condensation. Also, carboxyl is activated by thionyl chloride, carbodiimide or the like and forms amido bond or ester bond with amino or hydroxyl. In addition to these, the immobilization can be carried out by using the condensation of chlorosilyl or alkyl silyl with hydroxyl in the support silica gel surface or the ionic bond between a primary to quaternary amine and carboxyl or sulfonate.

The chromatography carrier having sulfoxide on its side chains which is obtained by the present invention can be applied to a liquid chromatography which uses a general open column, a high performance liquid chromatography in which quick separation is possible by packing it in a high-pressure column and feeding the mobile phase at a high pressure by a pump, a so-called solid phase extraction in which its handling is simplified by packing it in a small cartridge or the like, and the like. Each of these can be used in the separation operation of PCB and the like.

The separation method of the present invention consists of adding a sample containing, for example, aromatic compounds such as PCB, to a column packed with the aforementioned carrier obtained by the present invention; adding non-polar solvent such as hexane thereto to effect elution of components mainly consisting of aliphatic compounds such as mineral oil; and then recovering the aromatic compounds and carrying out their mutual separation by continuing elution with a solvent.

In that case, although the non-polar solvent may be used successively in the elution of aromatic compounds, more quick recovery becomes possible when the elution is carried out using a polar solvent such as acetone or an appropriate mixture of a polar solvent and a non-polar solvent.

Since specificity of the conventional silica gel, amino group-modified silica gel and the like for aromatic compounds is not so high, it is necessary to carry out the elution with a large volume of an organic solvent using a very long column to effect sufficient separation of PCB and the like from other substances. Contrary to this, since sulfoxide interact with benzene ring specifically, aromatic compounds such as PCB are apt to be retatined on the carrier of the present invention having sulfoxide, the aromatic compounds are slowly eluted in comparison with the majority of contaminants. Therefore, it becomes possible to carry out further efficient separation. When the separation conditions are further selected, it is possible to use the chromatography carrier not only for the rough separation of a group of compounds but also for the mutual separation of individual organic compounds.

In this connection, when a sample is passed through a short column or cartridge packed with silica gel or other absorbent before the chromatography which uses the carrier of the present invention, components which adhere irreversibly to these carriers can be removed in advance. When a sample to which such a pretreatment was applied is used, it becomes possible to use the carrier of the present invention repeatedly, by washing and regenerating it with polar solvent such as acetone and non-polar solvent such as hexane after the separation operation. Therefore, cost can be reduced.

### EXAMPLES

Although the following describes the present invention in detail based on examples, the following illustrative examples do not limit the present invention.

### Example 1

To 25 g of aminopropyl-modified silica gel (about 0.02 to 0.1 mm in particle diameter, 54 Å in pore diameter, 521 m²/g in specific surface area and 3.1 μmol/m² in amino group density), 25 g of 3-(methylthio)propionaldehyde (CH₃—S—(CH₂)₂—CHO) was added and allowed to undergo the reaction at 0° C. for 3 hours to effect its binding as imine. It was thoroughly washed with methanol and then dried in vacuo to confirm that 1.4 mmol of sulfide was immobilized per 1 g dry weight of the carrier as a result of weight analysis of sulfur in the thus obtained carrier. Accordingly, 29 mL of 0.05 M sodium metaperiodate aqueous solution was added to 10 g of the carrier. The reaction at 0° C. for 24 hours was carried out to effect oxidation of sulfide to sulfoxide. It was thoroughly washed with pure water and acetone and then dried in vacuo to obtain the carrier modified with sulfoxide. In a glass column of 10 mm in inner diameter (equipped with a fluoride resin cock), 2.5 g of the wet carrier was packed using acetone and used as a PCB separation column.

### Example 2

To a small column (8.5 mm in inner diameter) packed with 0.3 g of silica gel, 0.25 mL of a mineral oil (insulating oil for potential transformer) containing about 4 ppm of a PCB mixture (manufactured by KANEKA CORPORATION, a 1:1:1:1 mixture of Kanechlors 300, 400, 500 and 600) was added. The components irreversibly adhering to silica gel were adhered thereto followed by elution with 8 mL of hexane. Next, the eluate was concentrated to be 0.2 mL under nitrogen gas stream. it was applied to the aforementioned PCB separation column obtained in Example 1 and eluted with 6 mL of hexane and then with a hexane/acetone mixture (4:1 in volume ratio) to carry out separation of mineral oil and PCB.

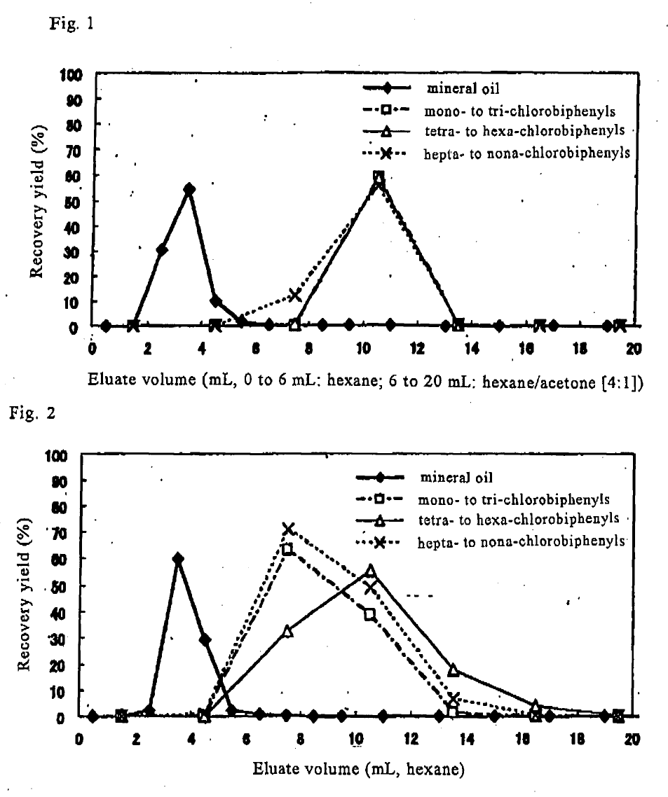

The elution patterns were prepared by recovering the eluate in appropriate portions and calculating the recovery yield of mineral oil from the weight of distillation residual components, and the recovery yield of PCB from the peak areas of respective PCB homologues obtained by concentrating each eluate to a predetermined concentration and injecting it into a gas chromatography-mass spectrometry (GC/MS). The elution patterns are shown in FIG. 1. As shown in FIG. 1, separation of PCB and mineral oil was good, and interference of peaks of the PCB homologues by the oil contents was not found on the chromatogram.

### Example 3

Into a four neck flask equipped with a condenser, 15 g of the aminopropyl-modified silica gel used in Example 1 was put, followed by adding 150 mL of anhydrous tetrahydrofuran and 5 g of triethylamine. In an atmosphere of nitrogen and while stirring the contents, 5 g of 3-(methylthio)propionic acid chloride (CH₃—S—(CH₂)₂—COCl) was gradually added thereto from a dropping funnel. After completion of addition of the whole portion, a reaction was carried out for 2 hours on a hot water bath of 80° C. with carrying out reflux to obtain a carrier to which sulfide was amido-bonded. It was thoroughly washed with methanol and then dried in vacuo to confirm that 0.84 mmol of sulfide was immobilized per 1 g dry weight of the carrier as a result of weight analysis of sulfur in the thus obtained carrier.

After collecting 5 g of the dry carrier, reaction with 0.6 mL of 30% hydrogen peroxide was carried out at room temperature for 7 days in 15 mL of acetone to effect oxidation of sulfide to sulfoxide. It was thoroughly washed with acetone and then dried in vacuo to obtain the carrier modified with sulfoxide. In a glass column, 2.5 g of the carrier was packed in the same manner as in Example 1 and used as a PCB separation column.

### Example 4

In the same manner as in Example 2, 0.25 mL of mineral oil (insulating oil for potential transformer) containing about 4 ppm of a PCB mixture (manufactured by KANEKA CORPORATION, a 1:1:1:1 mixture of Kanechlors 300, 400, 500 and 600) was treated with a small column packed with silica gel. The eluate eluted with hexane and concentrated in the same manner was applied to the PCB separation column obtained in Example 3 and eluted with hexane to carry out separation of mineral oil and PCB. Elution patterns of the mineral oil and PCB were obtained by the same method as Example 2 and are shown in FIG. 2. It was confirmed that the mineral oil components and PCB were properly separated similar to the Example.

### Comparative Example 1

In the same manner as in Example 1, 2.5 g of the aminopropyl-modified silica gel used in Example 1 was packed in a glass column and used as a PCB separation column.

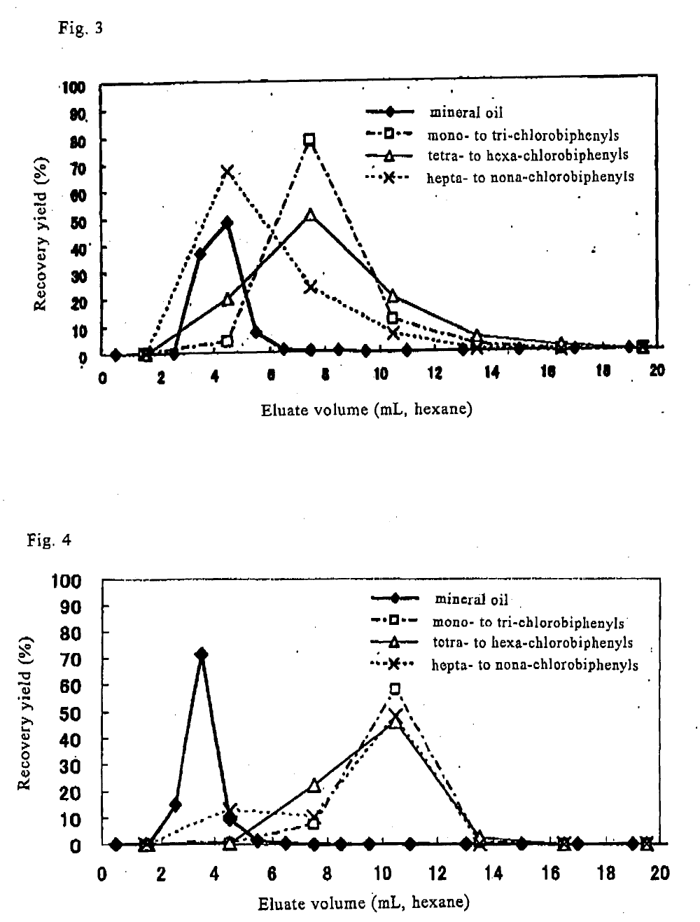

In the same manner as in Example 2, 0.25 mL of mineral oil (insulating oil for potential transformer) containing about 4 ppm of a PCB mixture (manufactured by KANEKA CORPORATION, a 1:1:1:1 mixture of Kanechlors 300, 400, 500 and 600) was treated with a small column packed with silica gel. The eluate eluted with hexane and concentrated in the same manner was applied to the PCB separation column and eluted with hexane to carry out separation of mineral oil and PCB. Elution patterns of the mineral oil and PCB were obtained by the same method of Example 2 and are shown in FIG. 3.

Different from the case of Examples 2 and 4, it was not able to separate the mineral oil components and PCB sufficiently. Since it was necessary to use at least 5 times of the carrier and solvent for elution in order to obtain the same separation capacity of Examples 2 and 4, high separation efficiency of the chromatography carrier by the present invention was confirmed.

### Example 5

Into a conical flask, 4 g of propyl carbonate-modified silica gel (0.02 to 0.1 mm in particle diameter, 54 Å in pore diameter, 521 m²/g in specific surface area and 0.8 mmol/g in carboxyl density) was put, followed by adding 25 mL of sodium phosphate buffer (pH 7.5), 1.9 g of 1-ethyl-3-(3-dimethylaminopropyl)-carbodiimide hydrochloride and 0.92 g of N-hydroxysuccinimide thereto to carry out a reaction at room temperature for 2.5 hours with stirring.

The support in which carboxyl was activated by carbodiimide was washed with the sodium phosphate buffer, followed by adding 25 mL of the sodium phosphate buffer and 1.7 g of DL-methionine sulfoxide thereto to carry out a reaction at room temperature for 2 hours with stirring. It was thoroughly washed with pure water and acetone and then dried in vacuo to obtain a carrier in which the carboxyl on the support surface and the amino in methionine sulfoxide are amido-bonded. As a result of weight analysis of sulfur in the carrier, it was confirmed that 0.7 mmol of sulfoxide was immobilized per 1 g dry weight of the carrier. In a glass column of 10 mm in inner diameter (equipped with a fluoride resin cock), 2.5 g of the wet carrier was packed using acetone and used as a PCB separation column. The column has good PCB separation performance.

### Example 6

Into an eggplant type flask equipped with a condenser, 15 g of silica gel (about 0.02 to 0.1 mm in particle diameter, 54 Å in pore diameter, 521 m²/g in specific surface area) was put, followed by adding 25 mL of anhydrous toluene thereto. In an atmosphere of nitrogen, 12.8 mL of thionyl chloride (SOCl₂) was gradually added thereto from a dropping funnel. After completion of addition of the whole portion, a reaction was carried out for 2 hours on a hot water bath of 80° C. while carrying out reflux. It was dried at 80° C. under a reduced pressure using a rotary evaporator to obtain a support in which the hydroxyl on the silica gel surface was replaced by chlorine.

A mixed liquid of 5 g of 3-(methylthio)propanol (CH₃—S—(CH₂)₃—OH), 20 mL of pyridine and 30 mL of tetrahydrofuran was added to the dry carrier. A reaction was carried out for 2 hours on a hot water bath of 80° C. while carrying out reflux. It was thoroughly washed with methanol and acetone and then dried in vacuo, to obtain the carrier modified with sulfide. As a result of weight analysis of sulfur in the carrier, it was confirmed that 0.84 mmol of sulfide was immobilized per 1 g dry weight of the carrier. After collecting 5 g of the dry carrier, it was allowed to react with 0.6 mL of 30% hydrogen peroxide at room temperature for 7 days in 15 mL of acetone to effect oxidation of sulfide to sulfoxide. It was thoroughly washed with acetone and then dried in vacuo to obtain the carrier modified with sulfoxide. In a glass column of 10 mm in inner diameter (equipped with a fluoride resin cock), 2.5 g of the wet carrier was packed using acetone and used as a PCB separation column. The column has good PCB separation performance.

### Example 7

To 0.7 g of 3-(methylthio)propionic acid (CH₃—S—(CH₂)₂—COOH), 10 mL of acetone and 0.7 mL of 30% hydrogen peroxide were added. A reaction was carried out at room temperature for 7 days to effect oxidation of sulfide to sulfoxide. On the other hand, 5 g of quaternary amine-modified silica gel (prepared by binding —(CH₂)₃N(CH₃)₃⁺Cl⁻ to the silica gel surface, about from 0.02 to 0.1 mm in particle diameter, 54 Å in pore diameter, 521 m²/g in specific surface area and 0.9 mmol/g in quaternary amine density) was washed with a sufficient volume of sodium bicarbonate aqueous solution to replace chloride ion by hydrogen carbonate ion, followed by washing with sufficient volumes of pure water and acetone. The aforementioned reaction liquid was directly added to it and dried at 35° C. under a reduced pressure using a rotary evaporator to obtain a carrier in which the carboxyl in sulfoxide was bound through ionic bond to the quaternary amino group on the silica gel surface. As a result of weight analysis of sulfur in the carrier, it was confirmed that 0.9 mmol of sulfoxide was immobilized per 1 g dry weight of the carrier. In a glass column of 10 mm in inner diameter (equipped with a fluoride resin cock), 2.5 g of the wet carrier was packed using acetone and used as a PCB separation column. This column has good PCB separation performance.

### Example 8

To 5 g of the aminopropyl-modified silica gel used in Example 1, 5 g of 3-(methylthio)propionaldehyde (CH₃—S—(CH₂)₂—CHO) was added. A reaction was carried out at 0° C. for 3 hours to effect its binding as imine. It was thoroughly washed with pure water, followed by adding 50 mL of pure water and 0.15 g of sodium borohydride thereto. A reaction at room temperature was carried out for 24 hours to reduce the imine to secondary amine. The carrier was washed with pure water and acetone and then dried in vacuo to confirm that 1.4 mmol of sulfide was immobilized per 1 g dry weight of the carrier as a result of weight analysis of sulfur in the thus obtained carrier. Accordingly, 15 mL of 0.05 M sodium metaperiodate aqueous solution was added to the carrier. The reaction was carried out at 0° C. for 24 hours to effect oxidation of sulfide to sulfoxide. It was thoroughly washed with pure water and acetone and then dried in vacuo to obtain the carrier modified with sulfoxide. In a glass column of 10 mm in inner diameter (equipped with a fluoride resin cock), 2.5 g of the wet carrier was packed using acetone and used as a PCB separation column. The column has good PCB separation performance.

### Example 9

Into an eggplant type flask equipped with a condenser, 5 g of the aminopropyl-modified silica gel of Example 1 was put, followed by adding 50 mL of anhydrous tetrahydrofuran and 1.7 g of triethylamine thereto. While stirring the contents, 3.2 g of 4-(methylthio)benzoyl chloride (CH₃—S—(C₆H₄)₂—COCl) was gradually added thereto. After completion of addition of the whole portion, a reaction was carried out for 2 hours on a hot water bath of 80° C. while carrying out reflux to obtain a carrier to which sulfide was amido-bonded. It was thoroughly washed with methanol and then dried in vacuo to confirm that 0.68 mmol of sulfide was immobilized per 1 g dry weight of the carrier as a result of weight analysis of sulfur in the thus obtained carrier.

After collecting 5 g of the dry carrier, a reaction with 0.38 mL of 30% hydrogen peroxide was carried out at room temperature for 7 days in 15 mL of acetone to effect oxidation of sulfide to sulfoxide. It was thoroughly washed with acetone and then dried in vacuo to obtain the carrier modified with sulfoxide. In the same manner as in Example 1, 2.5 g of the immobilized phase was packed in a glass column and used as a PCB separation column.

### Example 10

In the same manner as in Example 1, 0.25 mL of a mineral oil (insulating oil for potential transformer) containing about 4 ppm of PCB was treated with small column packed with a silica gel. It was applied to the aforementioned PCB separation column obtained in Example 9 and eluted with hexane to carry out separation of the mineral oil and PCB.

When elution patterns of the mineral oil and PCB were obtained by the same method as Example 2, it was confirmed that the mineral oil components and PCB were properly separated as shown in FIG. 4.

### Example 11

Into a conical flask equipped with a ground-in stopper, 1.6 g of acrylic resin particles having amino and hydroxyl on the surface (about. from 0.04 to 0.09 mm in particle diameter, 0.6 mmol/g in amino group density, 0.6 mmol/g in hydroxyl density) was put, followed by adding 25 mL of anhydrous tetrahydrofuran and 1 g of triethylamine thereto. While stirring the contents, 1 g of 3-(methylthio)propionic acid chloride (CH₃—S—(CH₂)₂—COCl) was gradually added thereto from a dropping funnel. After completion of addition of the whole portion, a reaction at room temperature was carried out for 2 hours while gently stirring to obtain a carrier to which sulfide was immobilized through amido bond and ester bond. It was thoroughly washed with methanol and then dried in vacuo to confirm that 1.0 mmol of sulfide was immobilized per 1 g dry weight of the carrier as a result of weight analysis of sulfur in the thus obtained carrier. After collecting 1.8 g of the dry carrier, reaction with 0.2 mL of 30% hydrogen peroxide was carried out at room temperature for 7 days in 12 mL of acetone to effect oxidation of sulfide to sulfoxide. It was thoroughly washed with acetone and then dried in vacuo to obtain the carrier modified with sulfoxide. In the same manner as in Example 1, 1.2 g of the carrier was packed in a glass column and used as a PCB separation column. The column has good PCB separation performance.

### Example 12

In a stainless column having an inner diameter of 4.4 mm and a length of 150 mm for high performance liquid chromatography use, 1.5 g of the carrier of Example 8 in which sulfoxide was immobilized was packed.

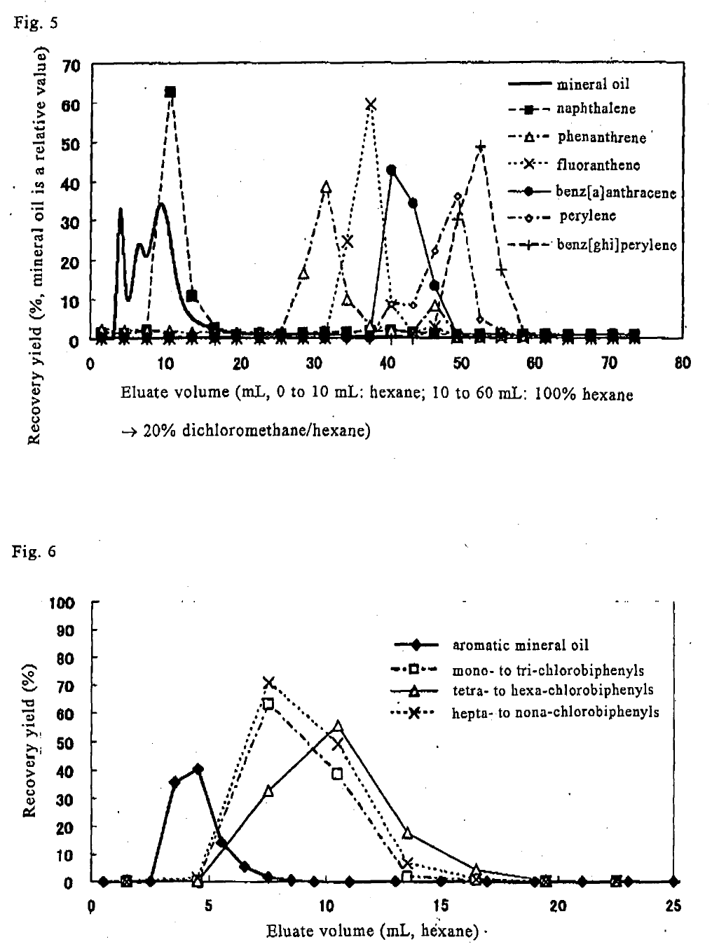

With 0.8 mL of hexane, 0.2 mL of mineral oil (insulating oil for potential transformer) containing various species of PAH (naphthalene, phenanthrene, fluoranthene, benz[a]anthracene, perylene, benz[ghi]perylene, 50 ppm for each) was diluted, and mutual separation of mineral oil and PAH was carried out by applying 20 μL of it to the aforementioned column obtained in Example 11 and eluting it by passing organic solvents through the column at a rate of 1 mL per minutes (0 to 10 minutes: 100% hexane, 10 to 60 minutes: linear gradient of 0 to 20% dichloromethane/hexane). The eluate was recovered in appropriate portions and injected into a gas chromatography-mass spectrometry (GC/MS). Elution patterns were prepared by calculating the recovery yield of PAH from the peak area of each PAH, and the recovery yield of mineral oil (relative value) from ultraviolet absorption (254 nm), respectively. The results are shown in Fig. As shown in FIG. 5, PAH having the number of aromatic rings of 3 or more can be clearly separated from mineral oil. Additionally, regarding mutual separation of PAH species, they can be properly separated when the number of aromatic rings is 2 or more. Thus, it was confirmed that the carrier is also effective for the separation of PAH.

### Example 13

In the same manner as in Example 2, 0.25 mL of a mineral oil (an insulating oil containing aromatic compounds (alkyl diphenyl alkane) as the main component) containing about 4 ppm of a PCB mixture (manufactured by KANEKA CORPORATION, a 1:1:1:1 mixture of Kanechlors 300, 400, 500 and 600) was treated with a small column packed with silica gel. The eluate eluted with hexane and concentrated in the same manner was applied to the PCB separation column obtained in Example 3 and eluted with hexane to carry out separation of mineral oil and PCB. Elution patterns of the mineral oil and PCB were obtained by the same method of Example 2 and are shown in FIG. 6. As a result, separation of mineral oil and PCB was confirmed, although its separation efficiency was slightly inferior to the mineral oil used in Example 2 which contains an aliphatic hydrocarbon as the main component.

### Example 14

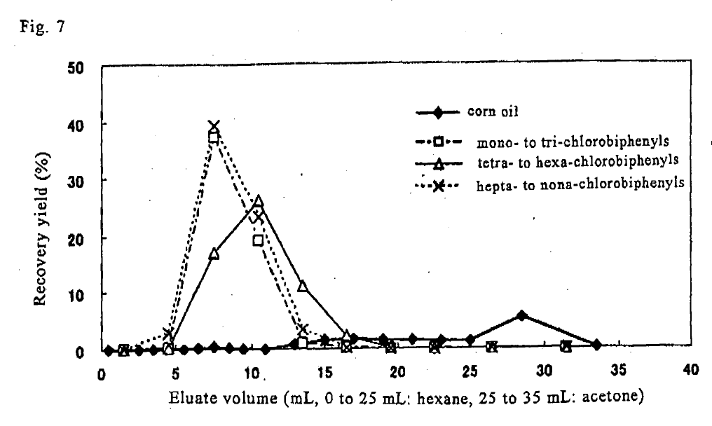

In the same manner as in Example 2, 0.25 mL portion of a plant oil (corn oil) containing about 4 ppm of a PCB mixture (manufactured by KANEKA CORPORATION, a 1:1:1:1 mixture of Kanechlors 300, 400, 500 and 600) was treated with a small column packed with silica gel. The eluate eluted with hexane and concentrated in the same manner was applied to the PCB separation column obtained in Example 3 and eluted with hexane and acetone to carry out separation of plant oil and PCB. Elution patterns of the plant oil and PCB were obtained by the same method as Example 2 and are shown in FIG. 7. As a result, it was confirmed that the plant oil components and PCB can be properly separated, since the great majority of the plant oil components are removed by irreversibly adhering to silica gel and the carrier of Example 3, and the great majority of the rest are also eluted later than PCB.

1. A chromatography carrier, in which an organic group comprising sulfoxide represented by the following formula (1) is directly immobilized to an organic solvent-insoluble support via covalent bond or ionic bond;
R₁—SO—R₂— (1)
wherein R₁ represents alkyl having from 1 to 3 carbon atoms, and R₂ represents a divalent hydrocarbon group having from 1 to 10 carbon atoms.

2. The chromatography carrier according to claim 1, wherein the chromatography carrier is a chromatography carrier for an aromatic compound.

3. The chromatography carrier according to claim 1 or 2, wherein the organic group comprising the sulfoxide represented by the aforementioned formula (1) is immobilized to the support via imine bond, amido bond or ester bond, or siloxane bond.

4. The chromatography carrier according to any one of claims 1 to 3, wherein the support is a porous particle selected from the group consisting of a polystyrene resin, a polyvinyl alcohol resin, titania and silica gel.

5. The chromatography carrier according to any one of claims 1 to 4, wherein particle diameter of the porous particle as the support is from 5 to 200 μm, and specific surface area thereof is from 100 to 700 m²/g.

6. The chromatography carrier according to any one of claims 1 to 5, wherein content of the sulfoxide represented by the aforementioned formula (1) is from 0.2 to 2.5 mmol/g per the support.

7. A chromatography column, in which the chromatography carrier described in any one of claims 1 to 6 is packed.

8. A method for separating an aromatic compound, which comprises adding a sample containing an aromatic compound to the chromatography column described in claim 7 to elute components other than the aromatic compound with a non-polar solvent, followed by eluting the aromatic compound successively with the non-polar solvent or with a solvent containing a polar solvent.

9. The method for separating an aromatic compound according to claim 8, wherein the aromatic compound is a halogenated aromatic compound.

10. The method for separating an aromatic compound according to claim 9, wherein the halogenated aromatic compound is polychlorobiphenyl.

11. The method for separating an aromatic compound according to claim 8, wherein the aromatic compound is a polycyclic aromatic hydrocarbon.
